(19) United States
(12) Patent Application Publication
(10) Pub. No.: US 2025/0119193 A1
(43) Pub. Date: Apr. 10, 2025

(54) METHOD AND APPARATUS FOR POWER CONTROL AND INTERFERENCE COORDINATION

(71) Applicant: Lenovo (Beijing) Limited, Beijing (CN)

(72) Inventors: Hongtao Zhang, Beijing (CN); Jianghui Liu, Beijing (CN); Haiming Wang, Beijing (CN); Haipeng Lei, Beijing (CN)

(73) Assignee: Lenovo (Beijing) Limited, Beijing (CN)

(21) Appl. No.: 18/293,732

(22) PCT Filed: Aug. 27, 2021
(86) PCT No.: PCT/CN2021/115104

§ 371 Date: Jan. 30, 2024

(51) Int. Cl. H04B 7/06

(52) U.S. Cl. CPC H04B 7/0626; H04B 7/063

(57) ABSTRACT

A method performed by a UE may include: receiving a pilot signal from a first number of first BSs; generating a serving BS matrix, wherein the serving BS matrix indicates that the UE accesses a second number of first BSs among the first number of first BSs; measuring CSI between the UE and each of the first number of first BSs; generating a CSI matrix based on the measured CSI between the UE and the first number of first BSs; encoding the serving BS matrix and the CSI matrix; and transmitting the encoded serving BS matrix and the encoded CSI matrix to one of the second number of first BSs.

### TECHNICAL FIELD

Embodiments of the present disclosure generally relate to wireless communication technology, and more particularly to power control and interference coordination in a wireless communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Interference coordination of wireless communication networks is a vital and open problem, where power control of a downlink is a feasible technology and the current optimal academic method is a weighted minimum mean square error (WMMSE) algorithm. However, it cannot be used in real networks because of its high complexity. Solutions with lower latency and reduced computation power are desired for handling power allocation and interference coordination among wireless communication networks.

### SUMMARY

Some embodiments of the present disclosure provide a method for wireless communication performed by a user equipment (UE). The method may include: receiving a pilot signal from a first number of first base stations (BSs); generating a serving BS matrix, wherein the serving BS matrix indicates that the UE accesses a second number of first BSs among the first number of first BSs; measuring channel state information (CSI) between the UE and each of the first number of first BSs; generating a CSI matrix based on the measured CSI between the UE and the first number of first BSs; encoding the serving BS matrix and the CSI matrix; and transmitting the encoded serving BS matrix and the encoded CSI matrix to one of the second number of first BSs.

Some embodiments of the present disclosure provide a method for wireless communication performed by a first BS. The method may include: receiving, from a user equipment (UE), information of serving BSs of the UE, wherein the information of serving BSs of the UE indicates that the UE accesses a second number of BSs among a first number of BSs and the first BS is one of the second number of BSs; receiving, from the UE, information associated with channel state information (CSI) between the UE and each of the first number of BSs; generating a local serving BS matrix based on the information of serving BSs of the UE; generating a local CSI matrix based on the information associated with the CSI; encoding the local serving BS matrix and the local CSI matrix; transmitting the encoded local BS matrix and the encoded local matrix to a second BS managing the first number of BSs; receiving a power allocation matrix from the second BS in response to the transmission of the encoded local BS matrix and the encoded local matrix; and applying a power allocation operation according to the power allocation matrix.

Some embodiments of the present disclosure provide a method for wireless communication performed by a second BS. The method may include: receiving first information of serving BSs of at least one user equipment (UE), wherein the first information indicates that the at least one UE accesses a plurality of first BSs among a first number of first BSs managed by the second BS; receiving second information associated with channel state information (CSI) between the at least one UE and each of the first number of BSs; generating a power allocation matrix based on the first and second information; and transmitting the power allocation matrix to the first number of first BSs.

Some embodiments of the present disclosure provide a UE. According to some embodiments of the present disclosure, the UE may include: a transceiver; and a processor coupled to the transceiver, wherein the transceiver and the processor may interact with each other to perform a method according to some embodiments of the present disclosure.

Some embodiments of the present disclosure provide a BS. The BS may be a macro base station (MBS) or a small base station (SBS). According to some embodiments of the present disclosure, the BS may include: a transceiver; and a processor coupled to the transceiver, wherein the transceiver and the processor may interact with each other to perform a method according to some embodiments of the present disclosure.

Some embodiments of the present disclosure provide an apparatus. The apparatus may be a UE or a BS (e.g., an MBS or SBS). According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an exemplary global CSI matrix in accordance with some embodiments of the present disclosure;

FIG. 3 illustrates an exemplary global serving SBS matrix in accordance with some embodiments of the present disclosure;

FIG. 4 illustrates a schematic architecture of an actor network in accordance with some embodiments of the present disclosure;

FIG. 5 illustrates a schematic architecture of a critic network in accordance with some embodiments of the present disclosure;

FIG. 6 illustrates an exemplary state representation in accordance with some embodiments of the present disclosure;

FIG. 7 illustrates an exemplary training process of a DDPG model in accordance with some embodiments of the present disclosure;

FIGS. 8-10 illustrate exemplary simulation results in accordance with some embodiments of the present disclosure;

FIG. 11 illustrates a flow chart of an exemplary procedure performed by a UE in accordance with some embodiments of the present disclosure;

FIG. 12 illustrates a flow chart of an exemplary procedure performed by a BS in accordance with some embodiments of the present disclosure;

FIG. 13 illustrates a flow chart of an exemplary procedure performed by a BS in accordance with some embodiments of the present disclosure; and

FIG. 14 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

For example, in the context of the present disclosure, user equipment (UE) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE includes wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art. The present disclosure is not intended to be limited to the implementation of any particular UE.

In the context of the present disclosure, a base station (BS) may also be referred to as an access point, an access terminal, a base, a base unit, a macro cell, a Node-B, an evolved Node B (eNB), a gNB, a Home Node-B, a relay node, or a device, or described using other terminology used in the art. The BS is generally a part of a radio access network that may include one or more controllers communicably coupled to one or more corresponding BSs. The present disclosure is not intended to be limited to the implementation of any particular BS.

In the context of the present disclosure, the UE may communicate with a BS via uplink (UL) communication signals. The BS may communicate with UE(s) via downlink (DL) communication signals.

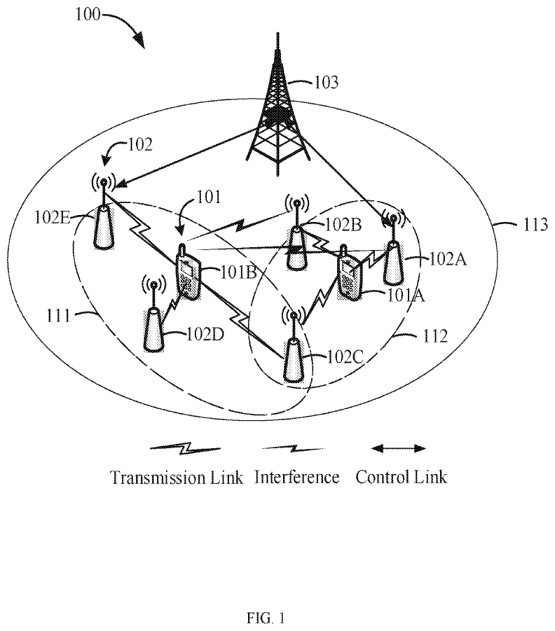

FIG. 1 illustrates a schematic diagram of a wireless communication system 100 in accordance with some embodiments of the present disclosure.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks. The present disclosure is not intended to be limited to the implementation of any particular wireless communication system architecture or protocol.

As shown in FIG. 1, a wireless communication system 100 may include some UEs 101 (e.g., UE 101A and UE 101B), and some BSs (e.g., macro BS (MBS) 103 and some small BSs (SBSs) 102 (e.g., SBSs 102A-102E)). Although a specific number of UEs and BS are depicted in FIG. 1, it is contemplated that any number of UEs and BSs may be included in the wireless communication system 100.

The SBS(s) 102 may also be referred to a micro BS, a Pico BS, a Femto BS, a low power node (LPN), a remote radio-frequency head (RRH) or described using other terminology used in the art.

The coverage of SBS(s) 102 is in the coverage 113 of MBS 103. MBS 103 and SBS(s) 102 can exchange data, signaling (e.g., control signaling), or both with each other via a backhaul link. MBS 103 may be used as a distributed anchor. SBS(s) 102 may have connections with users, e.g., UE(s) 101. In a user-centric network, each UE may be served by a cluster of SBSs which may be dynamically updated according to user movement. A UE can be served by more than one SBS, and an SBS can serve more than one UE, which may lead to cluster overlap. For example, referring to FIG. 1, UE 101A may be served by SBSs 102A-102C, which may form cluster 112. UE 101B may be served by SBSs 102C-102E, which may form cluster 111. SBSs 102A-102E are managed by MBS 103. The MBS may manage the local network including other SBSs.

Interference coordination in a wireless communication system is very important. For example, UE-to-UE, BS-to-UE, BS-to-BS, or any combination thereof may occur in a wireless communication system. For instance, as shown in FIG. 1, signals from SBSs 102A and 102B may become an interference to UE 101A. To solve the issue, power control of the downlink is applied. A current optimal academic method for DL power control is the WMMSE algorithm. However, due to its high complexity, it cannot be used in real networks.

In some examples, some artificial intelligence (AI)-based power allocation methods may be employed due to low latency and reduced computation power. These AI-based power allocation methods may use supervised learning which requires training datasets to train models and poses great dependence to the quality of data. The datasets may be generated by traditional iterative algorithms such as WMMSE. In these methods, the performances of the supervised learning-based models may be limited by traditional iterative algorithms and difficult to be improved. Additionally, they may not be proper to be scaled to large networks because of their significant performance degradation.

In some examples, reinforcement learning-based methods that do not require training datasets may be employed. However, the power allocation results of these methods are selected from finite discrete values, and may tend to miss the optimal solution.

Embodiments of the present disclosure provide solutions to solve the above issues. For example, prompt and efficient power allocation and interference coordination methods are provided. These methods have lower latency and reduced computation power. More details on the embodiments of the present disclosure will be illustrated in the following text in combination with the appended drawings.

In some embodiments of the present disclosure, a user-centric power control and interference coordination scheme based on deep deterministic policy gradient (DDPG) is applied. DDPG is advantageous because it does not need any training datasets and uses four neural networks to figure out a result more precisely than other models. This scheme can solve the above issues as well as the problem of unbalanced interference between cell edge users and central users. An MBS (e.g., a computation unit of the MBS) may run the DDPG based power control model.

The scheme can be summarized as follows and will be described in detail in the following text.
(1) SBSs send pilot signals to UEs.
(2) UEs access SBSs according to a certain method, such as the principle of signal strength or distance.
(3) Dynamically establish the serving SBS cluster for each UE with the movement of the UE.
(4) Each UE transmits encoded serving SBS matrix, CSI matrix(es) and normalized modulus factors to a corresponding serving SBS.
(5) SBSs collect the information from the UEs and generate local CSI and serving SBS matrices, which is encoded and transmitted to the MBS.
(6) The MBS generates the global “user-SBS” CSI and serving SBSs matrices, uses the matrices to train a DDPG power allocation model, and generates a power allocation matrix after the model is completed. The trained model may be deployed on the MBS (e.g., in a computation unit) and the DDPG model may be updated in every certain period. The MBS may generate the power allocation matrix according to a current CSI matrix and the matrix of serving SBS clusters.
(7) The power allocation matrix is transmitted to the SBSs for a power allocation operation.

In some embodiments of the present disclosure, the SBSs (e.g., SBSs 102A-102E in FIG. 1) may send pilot signals to a UE (e.g., UE 101A or UE 101B). The UE may measure the received signal power and channel state information (CSI) between the UE and the SBSs. The measurements may include at least one of amplitude, phase, real and imaginary parts associated with corresponding channels. The UE may calculate a normalized modulus factor.

The UE may select a certain number (denoted as “N”) of SBSs as a cluster of the serving SBSs according to signal strength or distance. For example, referring to FIG. 1, UE 101A may select SBSs 102A-102C as a cluster of serving SBSs, and UE 101B may select SBSs 102C-102E as a cluster of serving SBSs.

The UE may select N serving SBS according to various methods. In some examples, the UE may select N SBS with the strongest signal strength (e.g., reference signal received power (RSRP)) as the serving cluster. If there are two or more SBSs having the same signal strength, the UE may select the one nearest to the UE. In some examples, the UE may select N SBS with the closest distance to the UE as the serving cluster. If there are two or more SBSs having the same distance, the UE may select the one with the strongest signal strength. The serving cluster may be updated every period ΔT according to the movement of the UE.

The UE may formulate a matrix, the size of which may be based on the number of SBSs (denoted as “M”) from which pilot signals are received by the UE. For example, the size of the matrix may be 1 by M. Each element in the matrix may have one of two values, e.g., 1 or 0, wherein one (e.g., 1) of the two values represents the corresponding SBSs selected as the serving SBS, and the other (e.g., 0) of the two values represents the corresponding SBSs not selected as the serving SBS. For example, referring to FIG. 1, UE 101A may formulate a matrix of size of 1 by 5, e.g., [1 1 1 0 0]. The UE may determine an index of this serving SBS matrix according to a codebook (also referred to as “normalized codebook”). The size of the index of the serving SBS matrix (e.g., the number of bits of the index) may be determined by the number of matrixes in the codebook.

The UE may transmit the index of the serving SBS matrix to a serving SBS, which may be selected from the cluster of the serving SBSs of the UE according to various methods. For example, the selection may be based on the principle of signal strength or distance. For example, the selected SBS may be the one whose signal is the strongest to the UE. If there are two or more SBSs with the same strongest signal strength, the UE may select the nearest one. For example, the selected SBS may be the one nearest the UE. When there are two or more SBSs with the same nearest distance, the UE may select the SBS with the strongest signal strength.

The UE may also report the CSI to the serving SBS selected according to the above selection principle. As stated above, the UE measures the CSI between it and all SBSs. The UE may formulate at least one CSI matrix, the size of which may be based on the number M. For example, the size of the CSI matrix may be 1 by M. The elements in a CSI matrix are measurements of the UE with respect to corresponding SBSs. For example, referring to FIG. 1, UE 101A may generate a matrix [C1 C2 C3 C4 C5], wherein C1-C5 may be the amplitude, phase, real part or imaginary part measurements associated with the channel between UE 101A and SBSs 102A-102E, respectively.

In some examples, the UE may generate a matrix of channel amplitude information (hereinafter, “amplitude matrix”) and a matrix of channel phase information (hereinafter, “phase matrix”). In some examples, the UE may generate a matrix of the real parts associated with channel fading (hereinafter, “real part matrix”) and a matrix of the imagery parts associated with channel fading (hereinafter, “imagery part matrix”). In some examples, the UE may generate an amplitude matrix, a phase matrix, a real part matrix and an imagery part matrix. In some examples, the UE may generate the CSI matrixes based on certain criteria, such as the power from the SBSs. For instance, when the power from the SBS with the strongest signal is greater than or equal to a threshold, the UE may generate an amplitude matrix and a phase matrix, or a real part matrix and an imagery part matrix. Otherwise, when the power from the SBS with the strongest signal is less than the threshold, the UE may generate an amplitude matrix, a phase matrix, a real part matrix and an imagery part matrix. In other words, when channel quality is poor, an extra two indexes may be provided to improve channel recovery accuracy. In some examples, with the improvement of traffic requirements, the UE may generate an amplitude matrix, a phase matrix, a real part matrix and an imagery part matrix.

The UE may encode the generated CSI matrix(es). For example, the UE may determine an index of a CSI matrix according to a codebook, and transmit the index of the CSI matrix to a serving SBS. The size of the index of a CSI matrix (e.g., the number of bits of the index) may be determined by the number of matrixes in the codebook. The elements in each matrix of the codebook are quantified to several bits. The number of bits of the matrix element may be determined by a needed accuracy. A parity bit(s) may be added to the index of the CSI matrix for a transmission correctness check and error bit correction, if any. In some examples, the parity bit may be added to the end of the index.

Encoding a CSI matrix may include normalizing the CSI matrix with a corresponding normalized modulus factor, quantizing the normalized CSI matrix according to the needed accuracy, and comparing the quantized CSI matrix with matrices in the codebook to determine a corresponding index. Comparing the quantized CSI matrix with matrices in the codebook may include determining a matrix in the codebook which is most similar to the quantized CSI matrix. The index of the CSI matrix is the index of the most similar matrix in the codebook.

Various methods may be employed to determine the similarity of two matrixes. For example, at least one of the following methods may be employed:
(1) Calculate the mean and variance of the differences between two matrices. Define the similarity according to the value of mean and variance.
(2) Calculate cosine similarity.
(3) Calculate Pearson correlation coefficient.
(4) Calculate Jaccard coefficient.
(5) Calculate Tanimoto coefficient.
(6) Calculate Log-likelihood similarity.

The UE may also encode the normalized modulus factor for each CSI matrix and transmit the encoded normalized modulus factor to the selected SBS. Encoding a normalized modulus factor may include quantizing the factor according to a needed accuracy and determining the index of the normalized modulus factor according to a codebook. The number of bits of the quantized normalized modulus factor may be determined by a needed accuracy. In some examples, the quantized normalized modulus factor is compared with normalized modulus factors listed in the codebook to determine a normalized modulus factor in the codebook which is most similar to the quantized normalized modulus factor. The index of the normalized modulus factor is the index of the most similar factor in the codebook.

An SBS may collect information of serving SBSs of UE(s) served by the SBS (e.g., the index of serving SBS matrix) and information of the CSI between the UE(s) and SBSs (e.g., the index(es) of CSI matrix(es)). The SBS may generate a local serving BS matrix based on the information of serving SBSs and a local CSI matrix based on the information of the CSI. In some examples, the size of the above local matrixes may be based on the number of UEs (denoted as “U”) which transmit the above information to the SBS and M. For example, the size of the local matrixes may be U by M.

The SBS may also receive information of a normalized modulus factor (e.g., index of the normalized modulus factor) associated with the CSI. The SBS may generate a modulus factor matrix based on the information of the normalized modulus factor. In some examples, the size of the modulus factor matrix may be based on the U.

In some examples, the processes of generating the local serving BS matrix, local CSI matrix, or the modulus factor matrix may include a decoding process which is an inverse of the encoding process as described above with respect to the UE. For example, for an index of a serving SBS matrix received from a UE, the SBS may decode it as a serving SBS matrix of the size of 1 by M. The SBS may generate the local serving BS matrix by combining the decoded serving SBS matrix from the U UEs.

The SBS may encode the local serving BS matrix, local CSI matrix, and the modulus factor matrix, and may transmit the encoded matrixes to an MBS managing the SBS. For example, the SBS may determine indexes of the local serving BS matrix, local CSI matrix, and the modulus factor matrix, and transmit these indexed to the MBS. The encoding process as described above with respect to the UE may be similarly applied here for encoding the local serving BS matrix, local CSI matrix, and the modulus factor matrix described above may apply here and thus is omitted herein.

In response to the transmission of the encoded matrixes, the SBS may receive a power allocation matrix from the MBS. The SBS may apply a power allocation operation according to the power allocation matrix.

In response to receiving the indexes of the local serving BS matrix and local CSI matrix from the SBSs managed by the MBS, the MBS may generate a global CSI matrix and a global cluster of serving SBSs based thereon.

For example, the processes of generating the global CSI matrix and a global cluster of serving SBSs may include a decoding process which is an inverse of the encoding process as described above with respect to the SBS. For instance, the decode process may be based on the matrices in a normalized codebook and the received index information. The MBS may combine the decoded local serving BS matrix and local CSI matrix into the global CSI matrix and the global cluster of serving SBSs.

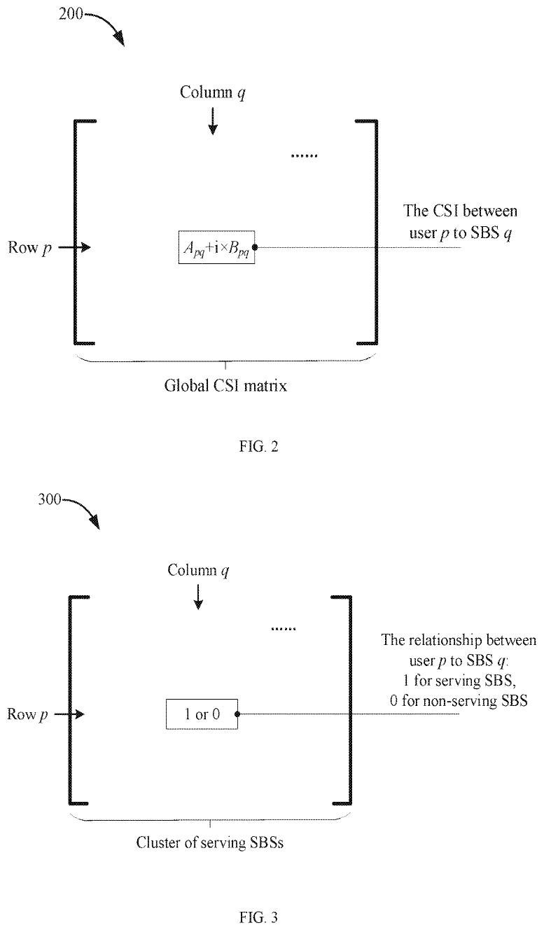

FIG. 2 illustrates an exemplary global CSI matrix 200 in accordance with some embodiments of the present disclosure. In FIG. 2, A_{pq} denotes the amplitude information associated with a channel between user (e.g., a UE) p and SBS q, and B_{pq} denotes the phase information associated with the channel between user p and SBS q. FIG. 3 illustrates an exemplary global cluster of serving SBSs 300 in accordance with some embodiments of the present disclosure.

The MBS may construct a DDPG model, and leverage the collected information to complete the model training offline. For example, the MBS may predict the power allocation matrix according to the generated global “users-SBSs” CSI matrix in real time and transmit the power allocation matrix to the SBSs. The SBSs operate the corresponding power control policy for its served users. The following text will describe the above process in detail.

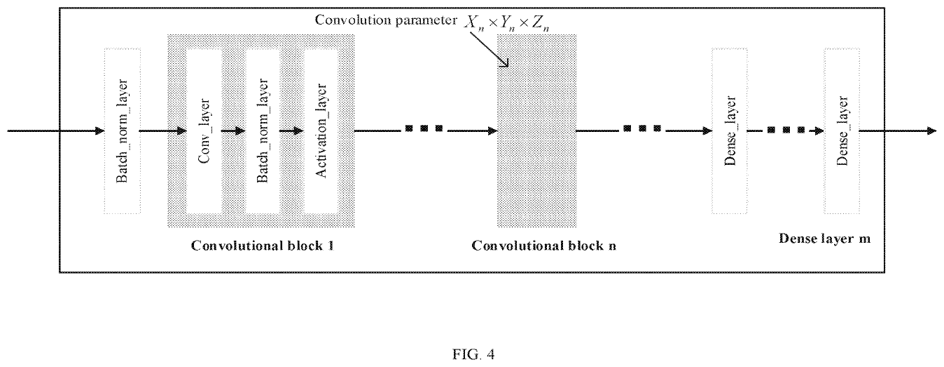

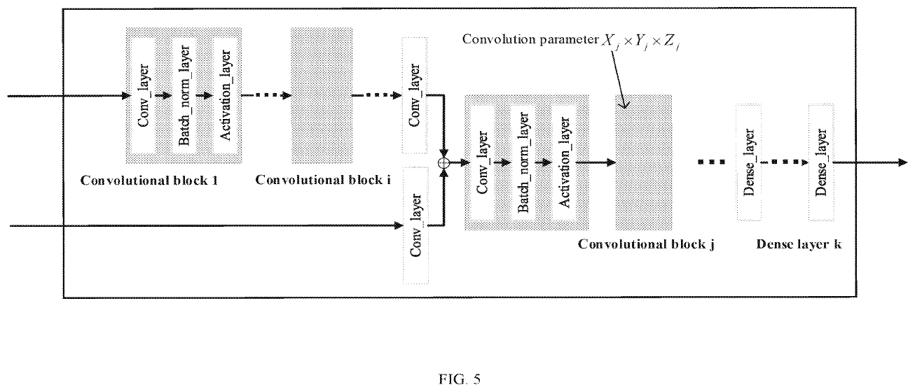

The MBS may use the global CSI matrix and the global cluster of serving SBSs (hereinafter, “global serving SBS matrix”) as the input to train the DDPG model. The DDPG model may be include four neural networks, for example, an actor current policy network, an actor target policy network, a critic current Q network and a critic target Q network. The two actor networks may have the same architecture, for example, as shown in FIG. 4. The two critic networks may have the same architecture, for example, as shown in FIG. 5. During the training of the DDPG model, an initiation power allocation matrix may be determined based on a principle of even distribution, and the state representation and the reward function may be carefully set.

As shown in FIG. 4, an actor network may include a batch normalization layer, at least one convolution block (e.g., convolution block 1 to convolution block n), and at least one dense layer (e.g., dense layer m). The convolution parameter of the convolution block n can be denoted as Xₙ×Yₙ×Zₙ (e.g., 3×3×16, 3×3×32, 3×3×64 and 3×3×128). The input of an actor network may be a state.

As shown in FIG. 5, a critic network may include two input branches, one of which may go through several convolution computations (e.g., convolution block 1 to convolution block i) before being combined with the other input. Then, the combination results may go through several convolutional blocks (e.g., convolution block 1 to convolution block j) and dense layers (e.g., dense layer k). The convolution parameter of the convolution block j can be denoted as Xⱼ×Yⱼ×Zⱼ (e.g., 3×3×16, 3×3×32, 3×3×64 and 3×3×128). One input of a critic network may be a state and the other may be a power allocation matrix.

The number of convolutional blocks as well as the number of dense layers for the actor network and the critic network may be determined by actual practice. The setting of the convolution parameters for the actor network and the critic network, including for example, the size of the convolution kernel (at least 1×1) and depth (at least one), may be determined by actual practice.

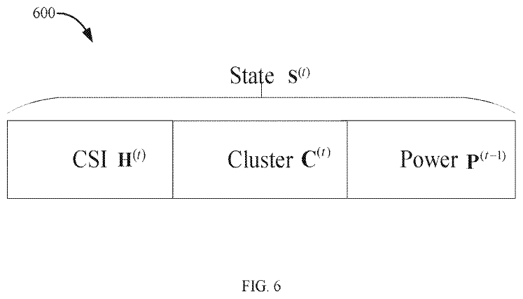

The state representation S^{(t)} in the training process may be expressed as the combination of current global CSI matrix H^{(t)}, current global serving SBS matrix C^{(t)} and a previous power allocation matrix P^{(t-1)}. FIG. 6 illustrates an exemplary state representation 600 in accordance with some embodiments of the present disclosure.

There are several options for the setting of the reward function. In some examples, the reward may be set as the value of a sum-rate of all users (e.g., UEs). In some examples, the reward may be set as the improvement of the sum-rate of all users (e.g., UEs). In some examples, the reward may be set as the global average received signal to interference noise ratio (SINR) of all users (e.g., UEs). In some examples, the reward may be set as the improvement of the global average received SINR of all users (e.g., UEs).

There are several options for setting an end of the training. In some examples, the completion of the training may be determined in response to at least one of the following: the number of iterations reaching a training episode threshold; obtaining the same reward for a number of iterations; and an improvement on the reward being less than or equal to a (e.g., positive) improvement threshold.

In response to the completion of the training, the MBS may deploy the trained DDPG model on the MBS (e.g., a computation unit of the MBS). The DDPG model may be updated according to a certain criterion. For instance, the DDPG model may be updated according to the information received from SBSs periodically. In some examples, the update period may be associated with a CSI report period of the UE. For instance, a fixed update period may be set according to K report periods of the user. In some examples, the update period may be dynamic, and may be based on a performance decline of the DDPG model relative to the WMMSE algorithm. For instance, when the performance achieved by the DDPG model is less than 80% of that achieved by the WMMSE algorithm, the DDPG model may be updated (e.g., a training process may be performed).

For the perspective of the MBS, the process of power control may include: receiving (e.g., periodically) information of the matrices of CSI and the serving SBSs transmitted by the SBSs, combining them into a global CSI matrix and a global serving SBS matrix, inputting it into the DDPG mode, which may output the power allocation matrix v^{(t)}, and transmitting the power allocation matrix v^{(t)} to the SBSs.

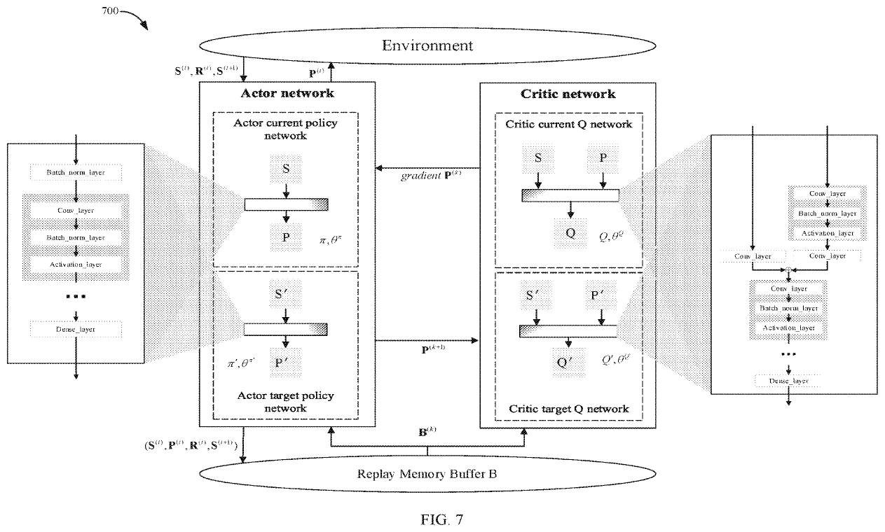

The following text describes an example of power allocation based on a DDPG model. FIG. 7 illustrates an exemplary training process of an example DDPG model in accordance with some embodiments of the present disclosure.

An application scenario may include an MBS used as a distributed anchor and several SBSs J={1, 2, . . . , J}, which connect with terminal users (e.g., UEs) I={1, 2, . . . I}, wherein user i is served by a cluster of SBSs Jᵢ={1, 2, . . . N}⊆J, which is dynamically updated according to the user's movement. Therefore, a user can be served by more than one SBS, and an SBS can also serve more than one user, which leads clusters to overlap. The MBS manages the local network including the SBSs. The SBSs collect the CSI matrix and send it to the MBS. The MBS predicts the power allocation matrix and transmits it to SBSs.

The users and the SBSs may be evenly distributed and the distance between user i and SBS j is denoted as d_{i,j}∈D∈C^{I×J} and may be used to initialize the CSI matrix which may be mainly determined by path loss and Rayleigh fading. The path loss (PL) model (in dB) may be represented as follows:

$${PL}_{i , j} = 148.1 + 37.6 \times log ( {d}_{i , j} ) \qquad ( 1 )$$

Not only the real part but also the imaginary part of the Rayleigh fading model follows an independent and identically distributed Gaussian process with zero mean.

The CSI matrix between user i and SBS j is represented as h_{i,j}∈H∈C^{I×J}, where H defines the CSI matrix between all users and all SBSs, and C^{(I×J)} denotes a collection of all I×J matrices. Note that the CSI is not a fixed dimension because users move between or within cells. v_{i,j}∈V∈C^{I×J} denotes the power allocation matrix at the transmitter between user i and SBS j, where data vector sᵢ is transmitted and E[sᵢ²]=1, E[sᵢsₖ]=0, for i≠k. Then, yᵢ is the received signal of the user i, which can be represented as:

$${y}_{i} = {\sum }_{j ∈ {\partial }_{i}} {v}_{i , j} {h}_{i , j} {s}_{i} + {\sum }_{k \neq i} {\sum }_{j ∈ {\partial }_{k}} {v}_{i , j} {h}_{i , j} {s}_{k} + {n}_{i} \qquad ( 2 )$$

where nᵢ˜CN(0, σᵢ²) denotes the white Gaussian noise vector. The rate Rᵢ of user i can be calculated as:

$${R}_{t} = {log}_{2} ( 1 + \frac{{( {\sum }_{j ∈ {J}_{i}} {v}_{i , j} \vert {h}_{i , j} \vert )}^{2}}{{\sum }_{k \neq j} {( {\sum }_{j ∈ {J}_{i}} {v}_{i , j} \vert {h}_{i , j} \vert )}^{2} + {σ}_{i}^{2}} ) \qquad ( 3 )$$

In order to maximize the sum-rate, the allocation of all SBS power is important, which can be written as the following problem to minimize interference

$$\text{?} {log}_{2} ( 1 + \frac{{( \text{?} \vert \text{?} \vert )}^{2}}{\text{?} {( \text{?} \vert \text{?} \vert )}^{2} + \text{?}} ) \qquad ( 4 )$$

$$s . t . 0 \leq \text{?} \leq {P}_{j} , j = 1 , 2 , … , J ,$$

$$\text{?} \text{indicates text missing or illegible when filed}$$

where vᵢ=[v_{i,1}, v_{i,2}, . . . v_{i,J}] represents the collection of power allocated by all SBSs to user i, Pⱼ denotes the power budget of SBS j, and α≥0 represents the weight of user i.

This non-deterministic polynomial (NP)-hard problem can be solved by introducing the variable w which is represented as

$${w}_{i}^{opt} = \frac{1}{1 - {u}_{i} {\sum }_{j ∈ {J}_{i}} \vert {h}_{i , j} \vert {v}_{i , j}} , \qquad ( 4 )$$

where uᵢ is denoted as

$${u}_{i}^{mmse} = \frac{{\sum }_{j ∈ {J}_{i}} {v}_{i , j} \vert {h}_{i , j} \vert}{{\sum }_{k ∈ I} {( {\sum }_{j ∈ {J}_{k}} {v}_{k , j} \vert {h}_{i , j} \vert )}^{2} + {σ}_{i}^{2}} \qquad ( 5 )$$

The optimal value of v_{i,j}(j∈Jᵢ) is

$${v}_{i , j}^{opt} = {[ \frac{{α}_{i} {w}_{i} {u}_{i} \vert {h}_{i , j} \vert - {\sum }_{k ∈ I} {α}_{k} {w}_{k} {u}_{k}^{2} {h}_{k , j} ( {\sum }_{l ∈ {J}_{i} , j \neq l} \vert {h}_{k , l} \vert {v}_{i , l} )}{{\sum }_{k ∈ I} {α}_{k} {w}_{k} {u}_{k}^{2} {\vert {h}_{k , j} \vert}^{2} + {λ}_{j}} ]}_{0}^{\sqrt{{P}_{j}}} \qquad ( 7 )$$

where λⱼ represents the Lagrange multiplier associated with the power budget constraint of BS j which satisfies Σᵢ₌₁^{I}(v_{i,j}(λⱼ))²=Pⱼ. λⱼ is solved by one dimensional search approaches (e.g., bisection method). Note that v_{i,j}=0 when j∉Jᵢ because SBSs out of the serving cluster do not transmit any data to the user.

The target problem can be solved by the time-consuming iteration of equations (5), (6), and (7), which cannot be used in practice.

DDPG is a reinforcement learning algorithm based on actor-critic, which uses deterministic strategies and is combined with neural networks. Its action set is a continuous value rather than a discrete value. The deterministic strategy is different from the random strategy in that it is not based on the probability distribution of uncertainty, but only takes an action with the highest probability. This allows it to train fewer times without missing the optimal value(s).

As stated above, a DDPG model may have four networks: an actor current policy network, an actor target policy network, a critic current Q network and a critic target Q network. These four networks are composed of neural networks with different parameter(s), where actor networks are used to generate deterministic policies, and critic networks are used to generate Q tables to evaluate the deterministic policies generated by actor networks. The Q table can be written as follows:

$${Q}^{π} ( {S}^{( t )} , {P}^{( t )} ) = {E}_{{R}^{( t )} , {S}^{( t - 1 )} \sim ξ} [ {R}^{( t )} ( {S}^{( t )} , {P}^{( t )} ) + γ [ {Q}^{π} ( {S}^{( t + 1 )} , π ( {S}^{( t + 1 )} ) ) ] ] \qquad ( 8 )$$

where π is the deterministic policy, ξ is the expectation distribution, and γ is the discount factor. R^{(t)}(S^{(t)}, P^{(t)}) denotes the reward of the power allocation matrix P^{(t)} and state S^{(t)}, which is a combination of CSI information H^{(t)} and the power allocation information p^{(t-1)} in the last time.

As stated above, such DDPG model can be used to relocate power and coordinate interference in wireless communication networks. In some examples, the actor current policy network may be responsible for power allocation. The parameters of the actor current policy network may be updated iteratively based on, for example, the output of the critic current Q network, where the power allocation may be completed according to a current state. The next state and current reward can be calculated by interacting with the environment. The actor target policy network may be responsible for calculating the optimal power allocation which may be determined according to the current state. For example, the parameters of the actor target policy network after the completion of the training process may be deployed for determining the power allocation matrix to be transmitted to SBSs. The parameters of the actor target policy network may be updated based on that of the actor current policy network. The critic current Q network may be responsible for calculating a Q value to evaluate the power allocation result of the actor current policy network, and promote the update of the actor current policy network to improve its performance, where a system sum-rate can be used as the reward and a discount factor can be leveraged to the current power allocation under the current state. The update of the critic current Q network may be based on the gradient descent using the sampled data in a replay memory buffer. The critic target Q network may be responsible for calculating a Q value to evaluate the power allocation result of the actor target policy network, and the detailed description regarding the critic current Q network can be similarly applied to the critic target Q network.

FIG. 7 illustrates an exemplary training process of an example DDPG model 700 in accordance with some embodiments of the present disclosure. The example DDPG model in FIG. 7 includes an actor current policy network, an actor target policy network, a critic current Q network and a critic target Q network.

During an initiation of the DDPG model, parameter θ^{π} of the actor current policy network is the same as parameter θ^{π′} of the actor target policy network and parameter θ^{Q} of the critic current Q network is the same as parameter θ^{Q′} of the critic target Q network.

The actor networks may be used for generating the deterministic policies π. Parameter θ^{π} of the actor current policy network may be updated based on the output of the critic current Q network. The parameter θ^{π′} of the actor target policy network may be updated through a sectional parameter transfer from the actor current policy network. Actor networks may be responsible for the following:
The actor current policy network receives input S^{(t)} from the environment (e.g., generated according to FIG. 6) and generates the power allocation P^{(t)} based on policy π, where P^{(t)}=π(S^{(t)}|θ^{π})+n^{(t)}, and n^{(t)} is noise in order to add randomness.
The state is updated to S^{(t+1)} (e.g., generated according to FIG. 6 with H^{(t)}, C^{(t)} and P^{(t)}) and the current reward R^{(t)} is calculated.
The actor current policy network can update the parameter θ^{π′} of the actor target policy network through the following:

$${θ}^{{π}^{′}} ← τ {θ}^{π} + ( 1 - τ ) {θ}^{{π}^{′}} \qquad ( 9 )$$

where τ is the parameter transfer ratio.

In some embodiments, the timing for updating the parameters of the actor target policy network may be based on a certain criterion, for example, periodically. For example, the parameters of the actor target policy network may be updated based on a certain number of iterations, e.g., every 50 or 100 iterations.

A state transition process group (S^{(t)}, P^{(t)}, R^{(t)}, S^{(t+1)}) may be put into a replay memory buffer B, and may be used as training datasets for the critic current Q network. The critic current Q network of the DDPG model may not be trained until the training datasets in B are more than a certain number β. For example, the first few iterations may only involve the generation of the state transition process groups until the number of the state transition process groups reach the number β. During the first few iterations, the parameters of the four networks may not be updated.

The critic networks are used for generating Q tables which are used to evaluate the decisions made by actor networks. The parameter θ^{Q} of the critic current Q network may be updated based on the gradient descent using the data stored in replay memory buffer B (e.g., based on equtaion (10) as shown below) and the parameter θ^{Q′} of the critic target Q network may be updated through parameter transfer from the critic current Q network. Critic networks may be responsible for the following:
The critic current Q network may (e.g., randomly) select M samples (e.g., M<<B) from B, and use the selected dataset as B^{(k)} to train the network parameter. For example, the selected dataset as B^{(k)} may be input to the four network for updating the network parameters. In some examples, the iteration associated with the selected dataset may occur every several iterations for generating the state transition process groups.
Critic Q networks evaluate the decisions made by actor networks.
After the actor target policy network generating power P^{(k+1)}=π′(S^{(k+1)}), P^{(k+1)} is used as one of the input data in the critic target Q network. And the other input data is S^{(k+1)}, which is from the selected dataset. According to the actor target policy network and the critic target Q network, the loss of the critic current Q network can be calculated as:

$$L = E [ {( {y}_{i} - Q ( {S}_{i} , {P}_{i} \vert {θ}^{Q} ) )}^{2} ] , \qquad ( 10 )$$

$$where$$

$${y}_{i} = R ( {S}_{i} , {P}_{i} ) + γ {Q}^{′} ( {S}_{i + 1} , {π}^{′} ( {S}_{i + 1} \vert {θ}^{{π}^{′}} ) \vert {θ}^{{Q}^{′}} ) .$$

The parameters of the critic current Q network can be updated according to the gradient descent of the loss. The strategy gradient calculation of the policy network can be expressed as:

$${∇}_{θ π} {J}_{β} ( π ) \approx {E}_{S \sim {ρ}^{β}} [ {∇}_{P} Q ( S , P \vert {θ}^{Q} ) {\vert}_{P = π ( S )} \cdot {∇}_{{θ}^{π}} π ( S \vert {θ}^{π} ) ] \qquad ( 11 )$$

Then, the parameters of the actor current policy network can be updated iteratively.
The critic target Q network can be updated through the following:

$${θ}^{{Q}^{′}} ← τ {θ}^{Q} + ( 1 - τ ) {θ}^{{Q}^{′}} \qquad ( 12 )$$

where τ is the parameter transfer ratio.

In some embodiments, the timing for updating the parameters of the critic target Q network may be based on a certain criterion, for example, periodically. For example, the parameters of the critic target Q network may be updated based on a certain number of iterations, e.g., every 50 or 100 iterations.

Equation (10) may be used to update the critic current Q network, and Equation (11) may be used to update the actor current policy network. After several iterative trainings, the DDPG model for user-centric power control may be completed.

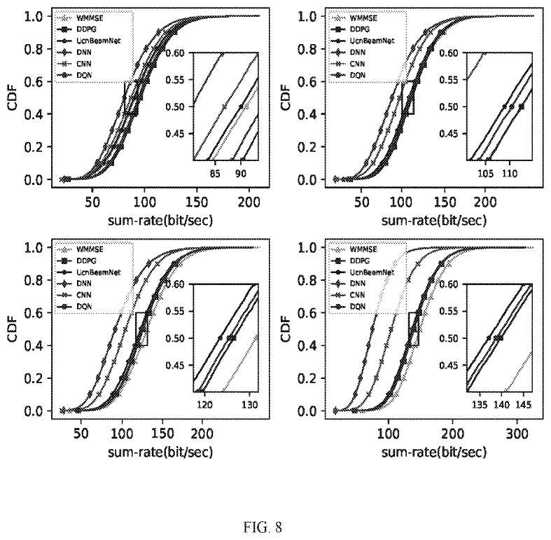

FIGS. 8-10 illustrate exemplary simulation results in accordance with some embodiments of the present disclosure.

FIG. 8 shows cumulative distribution function (CDF) curves of sum-rate in different scenarios where N=3: I=10, J=10 (Upper left); I=15, J=15 (Upper right); I=20, J=20 (lower left); I=25, J=25 (lower right).

With each user (e.g., a UE) connecting to 3 SBSs, FIG. 8 shows that when the network size is small (e.g., the two diagrams above), the performance of the power control algorithm based on DDPG is better than that of the WMMSE algorithm, and is superior to that of the ordinary convolutional neural network (CNN), deep neural network (DNN), deep Q-network (DQN), and even UcnBeamNet (a residual network).

With the increase of network size (e.g., the two diagrams below), the performance of the power control algorithm based on DDPG declines, but is still close to that of the WMMSE algorithm, similar to that of UcnBeamNet and DQN, and better than that of ordinary CNN and DNN. In other words, the DDPG algorithm has great potential to surpass UcnBeamNet, DQN and even WMMSE.

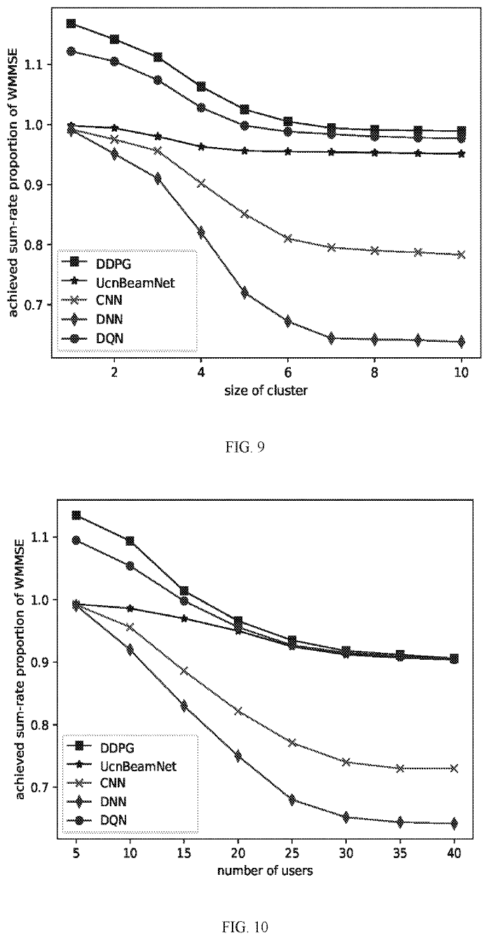

FIG. 9 shows the achieved sum-rate proportion of DDPG, UcnBeamNet, ordinary CNN, DNN, and DON relative to the WMMSE algorithm when I=10 and J=10 with different SBS clustering size N.

It can be seen that the performance of all algorithms decreases with the increase of N. However, the performance of the DDPG algorithm is always better than that of WMMSE, UcnBeamNet, DON, and far better than that of CNN and DNN. Specifically, the DDPG algorithm can improve performance by 16.2% compared with the WMMSE algorithm when N=1.

Moreover, while the number of clusters increases to 10, the performance of the DDPG algorithm is almost equal to that of the WMMSE algorithm, and the trend is relatively stable, which represents its performance will not decline sharply.

FIG. 10 shows the achieved sum-rate proportion of DDPG, UcnBeamNet, ordinary CNN, DNN, and DQN relative to the WMMSE algorithm when J=10 and N=3 with different user numbers I.

It can be seen that the performances of all algorithms decrease with the increase of the number of users. However, when user number I=5, the proposed DDPG method can improve the sum-rate performance by 13.5% compared with the WMMSE algorithm, and when the number of users becomes large, the performance of DDPG is still close to that of WMMSE and has similar performance to that of UcnBeamNet and DON, and is far superior to that of ordinary CNN and DNN.

Therefore, a power control model based on DDPG can be applied to different networks with relatively small performance loss.

Table 1 below shows a comparison between different algorithms on sum-rate and running time.

TABLE 1
Sum-rate and time consumption of different algorithms when N = 3

| (I, J, N) | Indicator | DNN | CNN | UcnBeamNet | DQN | DDPG | WMMSE |
|---|---|---|---|---|---|---|---|
| (10, 10, 3) | Average | 87.019 | 92.308 | 95.162 | 104.251 | 106.731 | 96.154 |
| (15, 15, 5) | sum-rate | 92.133 | 97.751 | 108.986 | 110.214 | 112.265 | 112.357 |
| (20, 20, 8) | (bit/s) | 96.254 | 103.667 | 124.401 | 125.014 | 125.696 | 129.584 |
| (25, 25, 10) | | 101.599 | 111.624 | 142.641 | 143.854 | 144.142 | 150.148 |
| (10, 10, 3) | Average | 0.108 | 0.120 | 0.221 | 0.112 | 0.113 | 48.214 |
| (15, 15, 5) | run time | 0.198 | 0.216 | 0.452 | 0.199 | 0.201 | 136.139 |
| (20, 20, 8) | (second/ | 0.915 | 0.987 | 2.104 | 0.941 | 0.953 | 856.846 |
| (25, 25, 10) | 1000 sample) | 2.967 | 3.452 | 7.635 | 3.024 | 3.158 | 7562.352 |

In small-scale networks such as I=10, J=10, N=3, the sum rate of DDPG can surpass that of WMMSE and other AI-based algorithms. Although the DDPG performance may decline compared to WMMSE as the network size increased, the running time is over a thousand times faster. For example, the computation time of the DDPG model is 3.158 seconds when I=25, J=25, N=10, which is two thousand times less than that of the WMMSE algorithm and is comparable to other AI-based methods. More importantly, it is an acceptable running time in reality.

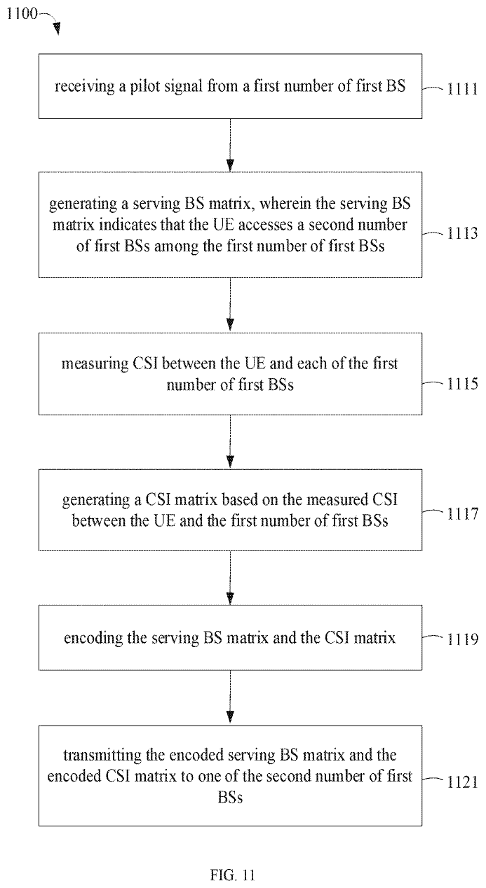

FIG. 11 illustrates a flow chart of an exemplary procedure 1100 performed by a UE in accordance with some embodiments of the present disclosure. Details described in all of the foregoing embodiments of the present disclosure are applicable for the embodiments shown in FIG. 11. In some examples, the procedure may be performed by UE 101 in FIG. 1.

Referring to FIG. 11, in operation 1111, a UE may receive a pilot signal from a first number of first BSs (e.g., SBSs). In operation 1113, the UE may generate a serving BS matrix, wherein the serving BS matrix may indicate that the UE accesses a second number of first BSs (e.g., N SBSs) among the first number of first BSs.

In some embodiments, the UE may select the second number of first BSs from the first number of first BSs according to one of the methods as described above. For example, the selection may be based on signal strengths or distances between the UE and the first number of first BSs.

In some embodiments, the serving BS matrix may include a first number of elements, each of which may correspond to a respective one of the first number of first BSs. An element of the serving BS matrix being a first value (e.g., 1) may indicate that a corresponding first BS is a serving BS of the UE, and an element of the serving BS matrix being a second value (e.g., 0) may indicate that a corresponding first BS is not a serving BS of the UE.

In operation 1115, the UE may measure CSI between the UE and each of the first number of first BSs. In operation 1117, the UE may generate a CSI matrix based on the measured CSI between the UE and the first number of first BSs.

In some embodiments, the CSI matrix may include a first matrix of channel amplitude information and a second matrix of channel phase information. In some embodiments, the CSI matrix may include a third matrix of a real part associated with channel fading and a fourth matrix of an imagery part associated with channel fading. In some embodiments, the CSI matrix may include the first, second, third and fourth matrixes.

In operation 1119, the UE may encode the serving BS matrix and the CSI matrix. In operation 1121, the UE may transmit the encoded serving BS matrix and the encoded CSI matrix to one of the second number of first BSs. In some embodiments, the UE may select the one of the second number of first BSs from the second number of first BSs according to one of the methods as described above. For example, the selection may be based on signal strengths or distances between the UE and the second number of first BSs.

In some embodiments, encoding the CSI matrix may include: normalizing the CSI matrix with a normalized modulus factor; quantizing the normalized CSI matrix according to an accuracy associated with a codebook; and comparing the quantized CSI matrix with matrices in the codebook to determine a most similar matrix in the codebook. Transmitting the encoded CSI matrix may include transmitting the index of the most similar matrix to the one of the second number of first BSs.

In some embodiments, the UE may add a parity bit to the index of the most similar matrix. Transmitting the index of the most similar matrix may include transmitting a combination of the parity bit and the index of the most similar matrix.

In some embodiments, comparing the quantized CSI matrix with the matrices in the codebook may include determining a similarity of the quantized CSI matrix and each matrix in the codebook by one of the following: calculating the mean and variance of the difference between the quantized CSI matrix and the corresponding matrix in the codebook; calculating a cosine similarity between the quantized CSI matrix and the corresponding matrix in the codebook; calculating a Pearson correlation coefficient between the quantized CSI matrix and the corresponding matrix in the codebook; calculating a Jaccard coefficient between the quantized CSI matrix and the corresponding matrix in the codebook; calculating a Tanimoto coefficient between the quantized CSI matrix and the corresponding matrix in the codebook; and calculating a Log-likelihood similarity between the quantized CSI matrix and the corresponding matrix in the codebook.

In some embodiments, the UE may encode the normalized modulus factor; and transmit the encoded normalized modulus factor to the one of the second number of first BSs.

It should be appreciated by persons skilled in the art that the sequence of the operations in exemplary procedure 1100 may be changed and some of the operations in exemplary procedure 1100 may be eliminated or modified, without departing from the spirit and scope of the disclosure.

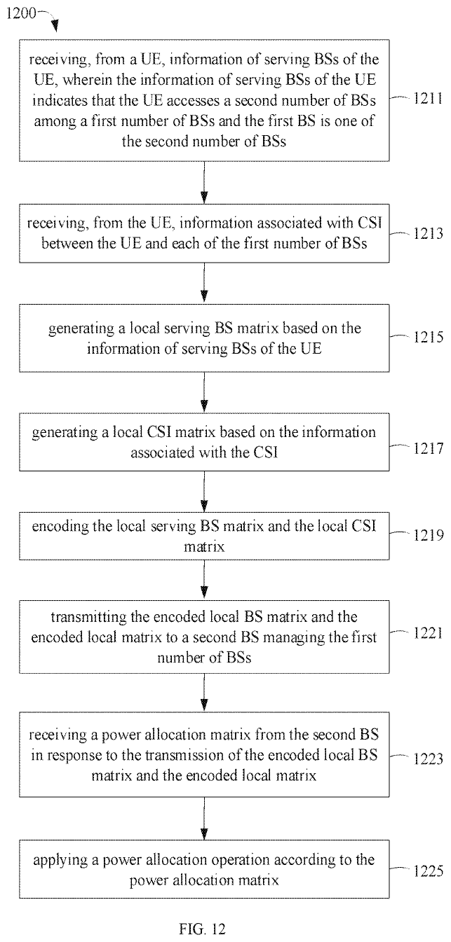

FIG. 12 illustrates a flow chart of an exemplary procedure 1200 performed by a BS in accordance with some embodiments of the present disclosure. Details described in all of the foregoing embodiments of the present disclosure are applicable for the embodiments shown in FIG. 12. In some examples, the procedure may be performed by SBS 102 in FIG. 1.

Referring to FIG. 12, in operation 1211, a BS (hereinafter, “first BS”) may receive, from a UE, information of serving BSs of the UE, wherein the information of serving BSs of the UE may indicate that the UE accesses a second number of BSs among a first number of BSs and the first BS is one of the second number of BSs. For example, the first BS may receive an index of a serving BS matrix.

In operation 1213, the first BS may receive, from the UE, information associated with CSI between the UE and each of the first number of BSs. For example, the first BS may receive an index of a CSI matrix. In some embodiments, the CSI between the UE and each of the first number of BSs may indicate at least one of the following information related to a channel between the UE and a corresponding BS: channel amplitude information and channel phase information; and a real part associated with channel fading and an imagery part associated with channel fading.

In operation 1215, the first BS may generate a local serving BS matrix based on the information of serving BSs of the UE. In operation 1217, the first BS may generate a local CSI matrix based on the information associated with the CSI. In operation 1219, the first BS may encode the local serving BS matrix and the local CSI matrix. In operation 1221, the first BS may transmit the encoded local BS matrix and the encoded local matrix to a second BS (e.g., an MBS such as MBS 103 in FIG. 1) managing the first number of BSs.

In some embodiments, the first BS may receive information of a normalized modulus factor associated with the CSI (e.g., index of the normalized modulus factor). The first BS may generate a modulus factor matrix based on the information of the normalized modulus factor, encode the modulus factor matrix, and transmit the encoded modulus factor matrix to the second BS.

In operation 1223, the first BS may receive a power allocation matrix from the second BS in response to the transmission of the encoded local BS matrix and the encoded local matrix. In operation 1225, the first BS may apply a power allocation operation according to the power allocation matrix.

It should be appreciated by persons skilled in the art that the sequence of the operations in exemplary procedure 1200 may be changed and some of the operations in exemplary procedure 1200 may be eliminated or modified, without departing from the spirit and scope of the disclosure.

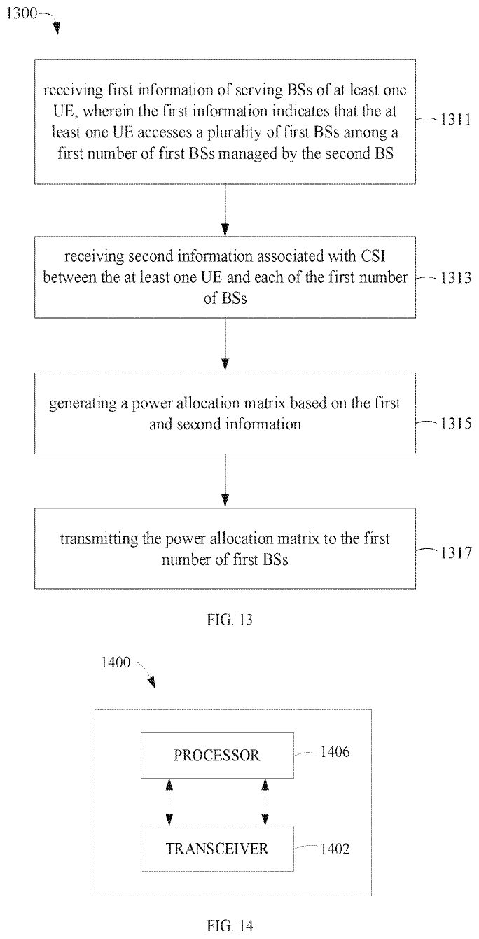

FIG. 13 illustrates a flow chart of an exemplary procedure 1300 performed by a BS in accordance with some embodiments of the present disclosure. Details described in all of the foregoing embodiments of the present disclosure are applicable for the embodiments shown in FIG. 13. In some examples, the procedure may be performed by MBS 103 in FIG. 1.

Referring to FIG. 13, in operation 1311, a BS (hereinafter, “second BS”) may receive first information of serving BSs of at least one UE, wherein the first information indicates that the at least one UE accesses a plurality of first BSs among a first number of first BSs managed by the second BS. For example, the first information may include an index of local serving BS matrix.

In operation 1313, the second BS may receive second information associated with CSI between the at least one UE and each of the first number of BSs. For example, the second information may include an index of local CSI matrix. In some embodiments, the CSI between each of the at least one UE and each of the first number of BSs may indicate at least one of the following information related to a channel between a corresponding UE and a corresponding BS: channel amplitude information and channel phase information; and a real part associated with channel fading and an imagery part associated with channel fading.

In operation 1315, the second BS may generate a power allocation matrix based on the first and second information. In operation 1317, the second BS may transmit the power allocation matrix to the first number of first BSs.

In some embodiments, the second BS may receive third information of a normalized modulus factor associated with the CSI. The third information may include an index of the normalized modulus factor. The second BS may determine a global CSI matrix based on the third information and the second information. In some embodiments, the second BS may further determine a global serving BS matrix based on the second information.

In some embodiments, generating the power allocation matrix based on the first and second information may include: determining a current state based on the global CSI matrix, the global serving BS matrix, and a previous power allocation matrix; inputting the current state to a DDPG model deployed on the second BS; and outputting the power allocation matrix by the DDPG model.

In some embodiments, the second BS may determine a deep deterministic policy gradient (DDPG) model for allocating transmission power of the first number of BSs. The second BS may train the DDPG model based on the global CSI matrix and the global serving BS matrix. The second BS may deploy the trained DDPG model on the second MBS in response to a completion of the training.

In some embodiments, the DDPG model may include: an actor current policy network for power allocation; a critic current Q network for evaluating a power allocation result of the actor current policy network; an actor target policy network for power allocation; and a critic target Q network for evaluating a power allocation result of the actor target policy network. The actor target policy network and the critic target Q network may be configured to update parameters of the critic current Q network.

In some embodiments, training the DDPG model may include: inputting a first state corresponding to a first time into the actor current policy network to generate a first power allocation matrix corresponding to the first time, wherein the first state is determined based on the global CSI matrix, the global serving BS matrix, and a previous power allocation matrix; iteratively updating parameters of the actor current policy network based on a gradient descent algorithm of an output of the critic current Q network; and for each iteration, determining a reward corresponding to the current time associated with a state corresponding to the current time and a power allocation matrix corresponding to the current time. In some embodiments, the previous power allocation matrix may be an initiation power allocation matrix determined based on a principle of even distribution. In some embodiments, training the DDPG model may further include: for each iteration, storing a state transition process group including the state corresponding to the current time, the power allocation matrix corresponding to the current time, the reward corresponding to the current time, and a state corresponding to a next time. The state corresponding to a next time may be determined based on the global CSI matrix, the global serving BS matrix and the power allocation matrix corresponding to the current time.

In some embodiments, training the DDPG model may further include: sampling a number of the stored state transition process groups; and updating the parameters of the critic current Q network based on a gradient descent algorithm using the sampled state transition process groups. For example, the parameters of the critic current Q network may be updated according to a gradient descent algorithm based on the minimum mean square error, which is calculated based on the reward and the outputs of the actor target policy network, critic current Q network, and critic target Q network. For example, the parameters of the critic current Q network may be updated according to Equation (10).

In some embodiments, training the DDPG model may include periodically updating parameters of the actor target policy network based on those of the actor current policy network. For example, the parameters of the actor target policy network may be updated according to Equation (9). In some embodiments, training the DDPG model may include periodically updating parameters of the critic target Q network based on those of the critic current Q network. For example, the parameters of the actor target policy network may be updated according to Equation (12).

In some embodiments, the second BS may determine the completion of the training in response to at least one of the following: the number of iterations reaching a training episode threshold; obtaining the same reward for a number of iterations; and an improvement on the reward being less than or equal to an improvement threshold.

In some embodiments, the reward may be one of the following: a sum-rate of the at least one UE (e.g., all UEs under the control of the MBS); an improvement on the sum-rate; a global average received signal to interference noise ratio (SINR) of the at least one UE; and an improvement on the global average received SINR.

In some embodiments, the DDPG model may include a plurality of convolutional neural networks, for example, the actor current policy network, the critic current Q network, the actor target policy network, and the critic target Q network. Each of the plurality of convolutional neural networks may include a plurality of convolutional blocks and a plurality of dense layers coupled to the plurality of convolutional blocks. Each of the plurality of convolutional blocks may include a convolutional layer, a batch normalization layer coupled to the convolutional layer, and an activation layer coupled to the batch normalization layer.

In some embodiments, the second BS may update the DDPG model deployed on the second BS according to an update period associated with a CSI report period of the at least one UE. In some embodiments, the second BS may update the DDPG model deployed on the second BS according to a performance decline of the DDPG model relative to a WMMSE algorithm.

It should be appreciated by persons skilled in the art that the sequence of the operations in exemplary procedure 1300 may be changed and some of the operations in exemplary procedure 1300 may be eliminated or modified, without departing from the spirit and scope of the disclosure.

FIG. 14 illustrates a block diagram of an exemplary apparatus 1400 according to some embodiments of the present disclosure.

As shown in FIG. 14, the apparatus 1400 may include at least one processor 1406 and at least one transceiver 1402 coupled to the processor 1406. The apparatus 1400 may be a UE or a BS (e.g., an SBS or an MBS).

Although in this figure, elements such as the at least one transceiver 1402 and processor 1406 are described in the singular, the plural is contemplated unless a limitation to the singular is explicitly stated. In some embodiments of the present application, the transceiver 1402 may be divided into two devices, such as a receiving circuitry and a transmitting circuitry. In some embodiments of the present application, the apparatus 1400 may further include an input device, a memory, and/or other components.

In some embodiments of the present application, the apparatus 1400 may be a UE. The transceiver 1402 and the processor 1406 may interact with each other to perform the operations with respect to the UE described in FIGS. 1-13. In some embodiments of the present application, the apparatus 1400 may be a BS (e.g., an SBS or an MBS). The transceiver 1402 and the processor 1406 may interact with each other to perform the operations with respect to the BS (e.g., an SBS or an MBS) described in FIGS. 1-13.

In some embodiments of the present application, the apparatus 1400 may further include at least one non-transitory computer-readable medium.

For example, in some embodiments of the present disclosure, the non-transitory computer-readable medium may have stored thereon computer-executable instructions to cause the processor 1406 to implement the method with respect to the UE as described above. For example, the computer-executable instructions, when executed, cause the processor 1406 interacting with transceiver 1402, to perform the operations with respect to the UE described in FIGS. 1-13.

In some embodiments of the present disclosure, the non-transitory computer-readable medium may have stored thereon computer-executable instructions to cause the processor 1406 to implement the method with respect to the BS (e.g., an SBS or an MBS) as described above. For example, the computer-executable instructions, when executed, cause the processor 1406 interacting with transceiver 1402 to perform the operations with respect to the BS (e.g., an SBS or an MBS) described in FIGS. 1-13.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive a pilot signal from a first number of first base stations (BSs);
generate a serving BS matrix, wherein the serving BS matrix indicates that the UE accesses a second number of first BSs among the first number of first BSs;
measure channel state information (CSI) between the UE and each of the first number of first BSs;
generate a CSI matrix based on the measured CSI between the UE and the first number of first BSs;
encode the serving BS matrix and the CSI matrix; and
transmit the encoded serving BS matrix and the encoded CSI matrix to one of the second number of first BSs.

2. The UE of claim 1, wherein the serving BS matrix comprises a first number of elements, each of which corresponds to a respective one of the first number of first BSs, and wherein an element of the serving BS matrix being a first value indicates that a corresponding first BS is a serving BS of the UE, or the element of the serving BS matrix being a second value indicates that the corresponding first BS is not the serving BS of the UE.

3. The UE of claim 1, wherein the CSI matrix comprises at least one of:
a first matrix of channel amplitude information and a second matrix of channel phase information; or
a third matrix of a real part associated with channel fading and a fourth matrix of an imagery part associated with the channel fading.

4. The UE of claim 1, wherein to encode and transmit the CSI matrix, the at least one processor is configured to cause the UE to:
normalize the CSI matrix with a normalized modulus factor;
quantize the normalized CSI matrix according to an accuracy associated with a codebook;
compare the quantized CSI matrix with matrices in the codebook to determine a most similar matrix in the codebook; and
transmit an index of the most similar matrix to the one of the second number of first BSs.

5. The UE of claim 4, wherein the at least one processor is configured to cause the UE to:
encode the normalized modulus factor; and
transmit the encoded normalized modulus factor to the one of the second number of first BSs.

6. A base station (BS) for wireless communication, comprising:
at least one memory; and
at least one processor coupled with the at least one memory and configured to cause the BS to:
receive, from a user equipment (UE), information of serving BSs of the UE, wherein the information of the serving BSs of the UE indicates that the UE accesses a second number of BSs among a first number of BSs and the BS is one of the second number of BSs;
receive, from the UE, information associated with channel state information (CSI) between the UE and each of the first number of BSs;
generate a local serving BS matrix based on the information of the serving BSs of the UE;
generate a local CSI matrix based on the information associated with the CSI;
encode the local serving BS matrix and the local CSI matrix;
transmit the encoded local BS matrix and the encoded local matrix to an additional BS managing the first number of BSs;
receive a power allocation matrix from the additional BS in response to transmission of the encoded local BS matrix and the encoded local matrix; and
apply a power allocation operation according to the power allocation matrix.

7. A base station (BS) for wireless communication, comprising:
at least one memory; and
at least one processor coupled with the at least one memory and configured to cause the BS to:
receive first information of serving BSs of at least one user equipment (UE), wherein the first information indicates that the at least one UE accesses a plurality of first BSs among a first number of first BSs managed by the second BS;
receive second information associated with channel state information (CSI) between the at least one UE and each of the first number of BSs;
generate a power allocation matrix based on the first and second information; and
transmit the power allocation matrix to the first number of first BSs.

8. The BS of claim 7, wherein the at least one processor is configured to cause the BS to:
receive third information of a normalized modulus factor associated with the CSI;
determine a global CSI matrix based on the third information and the second information; and
determine a global serving BS matrix based on the second information.

9. The BS of claim 8, wherein to generate the power allocation matrix based on the first and second information, the at least one processor is configured to cause the BS to:
determine a current state based on the global CSI matrix, the global serving BS matrix, and a previous power allocation matrix;
input the current state to a deep deterministic policy gradient (DDPG) model deployed on the BS; and
output the power allocation matrix by the DDPG model.

10. The BS of claim 8, wherein the at least one processor is configured to cause the BS to:
determine a deep deterministic policy gradient (DDPG) model for allocating transmission power of the first number of BSs;
train the DDPG model based on the global CSI matrix and the global serving BS matrix; and
in response to a completion of the trained DDPG model, deploy the trained DDPG model on the BS.

11. The BS of claim 10, wherein the DDPG model comprises:
an actor current policy network for power allocation;
a critic current Q network for evaluating a power allocation result of the actor current policy network;
an actor target policy network for power allocation; and
a critic target Q network for evaluating a power allocation result of the actor target policy network, wherein the actor target policy network and the critic target Q network are configured to update parameters of the critic current Q network.

12. The BS of claim 11, wherein to train the DDPG model, the at least one processor is configured to cause the BS to:
input a first state corresponding to a first time into the actor current policy network to generate a first power allocation matrix corresponding to the first time, wherein the first state is determined based on the global CSI matrix, the global serving BS matrix, and a previous power allocation matrix;
iteratively update parameters of the actor current policy network based on a gradient descent algorithm of an output of the critic current Q network; and
for each iteration, determine a reward corresponding to the current time associated with a state corresponding to the current time and a power allocation matrix corresponding to the current time.

13. The BS of claim 12, wherein the at least one processor is configured to cause the BS to determine the completion of the trained DDPG model in response to at least one of:
a number of iterations reaching a training episode threshold;
obtaining a same reward for a number of iterations; or
an improvement on the reward being less than or equal to an improvement threshold.

14. The BS of claim 12, wherein the reward is one of:
a sum-rate of the at least one UE;
an improvement on the sum-rate;
a global average received signal to interference noise ratio (SINR) of the at least one UE; or
an improvement on the global average received SINR.

15. The BS of claim 9, wherein the at least one processor is configured to cause the BS to:
update the DDPG model deployed on the second BS according to an update period associated with a CSI report period of the at least one UE; or
update the DDPG model deployed on the BS according to a performance decline of the DDPG model relative to a weighted minimum mean square error (WMMSE) algorithm.

16. A processor for wireless communication, comprising:
at least one controller coupled with at least one memory and configured to cause the processor to:
receive a pilot signal from a first number of first base stations (BSs);
generate a serving BS matrix, wherein the serving BS matrix indicates that user equipment (UE) accesses a second number of first BSs among the first number of first BSs;
measure channel state information (CSI) between the UE and each of the first number of first BSs;
generate a CSI matrix based on the measured CSI between the UE and the first number of first BSs;
encode the serving BS matrix and the CSI matrix; and
transmit the encoded serving BS matrix and the encoded CSI matrix to one of the second number of first BSs.

17. The processor of claim 16, wherein the serving BS matrix comprises a first number of elements, each of which corresponds to a respective one of the first number of first BSs, and wherein an element of the serving BS matrix being a first value indicates that a corresponding first BS is a serving BS of the UE, or the element of the serving BS matrix being a second value indicates that the corresponding first BS is not the serving BS of the UE.

18. The processor of claim 16, wherein the CSI matrix comprises at least one of:
a first matrix of channel amplitude information and a second matrix of channel phase information; or
a third matrix of a real part associated with channel fading and a fourth matrix of an imagery part associated with the channel fading.

19. The processor of claim 16, wherein to encode and transmit the CSI matrix, the at least one controller is configured to cause the processor to:
normalize the CSI matrix with a normalized modulus factor;
quantize the normalized CSI matrix according to an accuracy associated with a codebook;
compare the quantized CSI matrix with matrices in the codebook to determine a most similar matrix in the codebook; and
transmit an index of the most similar matrix to the one of the second number of first BSs.

20. The processor of claim 19, wherein the at least one controller is configured to cause the processor to:
encode the normalized modulus factor; and
transmit the encoded normalized modulus factor to the one of the second number of first BSs.
